(19) United States
(12) Patent Application Publication
(10) Pub. No.: US 2016/0363476 A1
(43) Pub. Date: Dec. 15, 2016

(54) Electronic Weight Measuring Fishing Net

(71) Applicant: Chase Innovations, LLC, Nampa, ID (US)

(72) Inventors: Chadd Van Komen, Nampa, ID (US); Edward J. Kim, Worcester, MA (US); Michael D. Chase, Bozeman, MT (US)

(21) Appl. No.: 14/737,160

(22) Filed: Jun. 11, 2015

(51) Int. Cl. G01G 19/60; G01G 19/414

(52) U.S. Cl. CPC G01G 19/60; G01G 19/414

(57) ABSTRACT

Novel tools and techniques might provide for implementing electronic weight measurement using a handheld apparatus (e.g., fishing net or other handheld apparatus, etc.). In some embodiments, the handheld apparatus might measure a raw signal weight of an item (e.g., fish or other suitable item), and might measure at least one of angle of tilt or angle of rotation of the item with respect to the handheld apparatus, and, in some cases, might also measure at least one of angle of tilt or angle of rotation of the item with reference to gravitational direction of the Earth. The handheld apparatus might calculate a processed signal weight of the item based at least in part on the measured angle of tilt and/or rotation of the item with respect to the at least one of the weight measurement sensor or the handle, and might display the processed signal weight of the item.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD

The present disclosure relates, in general, to methods, apparatuses, systems, and computer software for implementing weight measurement, and, in particular embodiments, to methods, apparatuses, systems, and computer software for implementing electronic weight measurement using a handheld apparatus.

### BACKGROUND

In sport or recreational fishing, size of the fish when caught is important. Some locations have laws, rules, regulations, or customs that require fish smaller or lighter than a prescribed length and/or weight to be released when caught. For sport fishing, the larger or heavier the fish, the better for the fisher person, particularly for competitions, bragging rights, or the like.

Traditionally, when a fish has been caught (e.g., using a fishing pole or fishing rod, or the like), a handheld fishing net is used to scoop up the caught fish. Such nets, however, typically do not have the capability to measure the weight of the fish. As a result, the fish has to be transferred to a separate device (e.g., weighing scale or the like)—in most cases, by re-hooking or clamping the fish to the separate device. This process, however, increases the time that the fish is kept out of the water and requires additional handling of the fish, and thus may distress the fish or may even cause physical strain or damage to the fish. For fish that must be (or are intended to be) released after being caught, such distress, strain, and/or damage is unacceptable. For the person catching the fish, the process of transferring the fish to the separate device is time consuming, inefficient, and inconvenient. In addition, weight comparisons of the fish with previously caught fish typically involve the fisher person to write (or type) down the weights and to compile and compare the weights, which is also time consuming, inefficient, and inconvenient.

In some customized fishing nets, mechanical weight measurement sensors have been integrated into the fishing nets. However, the mechanical measurement-type fishing nets either present a complex setup or require the user to hold the net in a vertical orientation (since the spring pull direction is parallel with the handle), which represents an awkward position for the user in terms of carrying and holding the fish for weight measurement. Further, as with most mechanical systems, wear and damage to components are to be expected and will typically lead to unreliable results over time. More recently, two-part handle systems that can rotate with respect to each other have also been used in handheld fishing nets. However, with the two-part handle systems, the fishing net must be held a certain way so as not to affect the rotation difference between the two segments and to avoid changing the results of the measurement. Holding the fishing net at such a non-rotated orientation for the amount of time it takes to ensure the measurement is performed and/or is accurate may be awkward, and can be very difficult in the case that the fish weighs several pounds.

Hence, there is a need for more robust and efficient solutions for implementing handheld apparatus-based weight measurement, by, e.g., implementing electronic weight measurement using a handheld apparatus (e.g., fishing net, etc.) that, in some cases, takes into account measurement deviations due to rotational, tilt, or angular orientation of the handheld apparatus during measurement.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. In some instances, a sub-label is associated with a reference numeral to denote one of multiple similar components. When reference is made to a reference numeral without specification to an existing sub-label, it is intended to refer to all such multiple similar components.

FIG. 1 is a schematic diagram illustrating an exemplary handheld apparatus for implementing electronic weight measurement, in accordance with various embodiments.

FIGS. 2A and 2B are schematic block diagrams illustrating various systems for implementing electronic weight measurement using a handheld apparatus, in accordance with various embodiments.

FIGS. 3A-3E are schematic diagrams illustrating various rotational, tilt, or angular orientations of an exemplary handheld apparatus that are taken into account when implementing electronic weight measurement, in accordance with various embodiments.

FIG. 4 is a schematic diagram illustrating various embodiments of a system for implementing electronic weight measurement using a handheld apparatus.

FIG. 5 is a flow diagram illustrating a method for implementing electronic weight measurement using a handheld apparatus, in accordance with various embodiments.

FIG. 6 is a block diagram illustrating an exemplary computer or system hardware architecture, in accordance with various embodiments.

FIG. 7 is a block diagram illustrating a networked system of computers, computing systems, or system hardware architecture, which can be used in accordance with various embodiments.

### DETAILED DESCRIPTION OF CERTAIN EMBODIMENTS

Overview

Various embodiments provide techniques for implementing electronic weight measurement using a handheld apparatus (e.g., fishing net, other suitable handheld apparatus, etc.) that, in some cases, takes into account measurement deviations due to rotational, tilt, or angular orientation of the handheld apparatus during measurement. The various embodiments also allow for an object to be weighed by utilizing load cells and applicable electronics without the need for multiple separate handle segments (as in conventional two-part handle systems).

In some embodiments, a handheld apparatus—which might include, without limitation, a handheld fishing net, a fishing rod, a handheld measuring rod, a handheld measuring scale, a handheld item-lifting rod, a shoulder-mounted carrying rod, a handheld baggage scale, and/or the like—might comprise a weight measurement sensor(s), a rotation sensor(s), a processor(s), and a display device(s), or the like. The weight measurement sensor(s) might measure a raw signal weight of an item (including, but not limited to, a fish, a small mammal, a small reptile, a food item, a manufactured item, one or more carrying containers, a piece of baggage, and/or the like) that is in load-bearing connection with the handheld apparatus. The rotation sensor(s) might measure at least one of angle/tilt or rotation of the item with respect to at least one of the weight measurement sensor or a handle of the handheld apparatus, and, in some cases, might also measure at least one of angle/tilt or rotation of the item with reference to gravitational direction of the Earth. The processor(s) might calculate a processed signal weight of the item based at least in part on the measured at least one angle/tilt or rotation of the item with respect to the at least one of the weight measurement sensor or the handle. The display device(s) might display the processed signal weight of the item.

In some cases, the weight measurement sensor(s) might include a load cell including, without limitation, a strain gauge load cell, a piezoelectric load cell, a capacitive load cell, a compression load cell, a compression/tension load cell, an S-beam load cell, a bending beam load cell, a platform load cell, a single point load cell, a canister load cell, a low profile load cell, and/or the like. The rotation sensor(s) might include, but is not limited to, an accelerometer, a gyroscope, a rotary encoder, an inclinometer, a rotary variable differential transformer, a tilt sensor, and/or the like.

According to some embodiments, the handheld apparatus might further include, without limitation, at least one of a wireless communications device, a data storage device, an audio input/output device, a location determination device, a clock, and/or the like. The wireless communications device might send the processed signal weight of the item to one or more external user devices for display on a display device of at least one of the one or more external user devices (including, but not limited to, at least one of a smart phone, a mobile phone, a smart watch, a personal digital assistant, a tablet computer, a laptop computer, a desktop computer, a stand-alone display device, and/or the like). The data storage device might store the processed signal weight of the item. The audio input/output device might allow the user to verbally instruct the apparatus to perform any of the above functionalities; to verbally record notes (e.g., what item is being measured, personal notes associated with the item being measured, etc.); to present options for selecting functionalities, external devices, networks, etc. to the user; to receive verbal user selection of functionalities, external devices, networks, etc.; and/or the like. The location determination device and the clock, in conjunction with the data storage device, allow for storing weight measurements together with location where the item is being measured, along with time and date, or the like.

The following detailed description illustrates a few exemplary embodiments in further detail to enable one of skill in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art, however, that other embodiments of the present invention may be practiced without some of these specific details. In other instances, certain structures and devices are shown in block diagram form. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features.

Unless otherwise indicated, all numbers used herein to express quantities, dimensions, and so forth used should be understood as being modified in all instances by the term “about.” In this application, the use of the singular includes the plural unless specifically stated otherwise, and use of the terms “and” and “or” means “and/or” unless otherwise indicated. Moreover, the use of the term “including,” as well as other forms, such as “includes” and “included,” should be considered non-exclusive. Also, terms such as “element” or “component” encompass both elements and components comprising one unit and elements and components that comprise more than one unit, unless specifically stated otherwise.

The tools provided by various embodiments include, without limitation, methods, systems, and/or software products. Merely by way of example, a method might comprise one or more procedures, any or all of which are executed by a computer system. Correspondingly, an embodiment might provide a computer system configured with instructions to perform one or more procedures in accordance with methods provided by various other embodiments. Similarly, a computer program might comprise a set of instructions that are executable by a computer system (and/or a processor therein) to perform such operations. In many cases, such software programs are encoded on physical, tangible, and/or non-transitory computer readable media (such as, to name but a few examples, optical media, magnetic media, and/or the like).

Various embodiments described herein, while embodying (in some cases) software products, computer-performed methods, and/or computer systems, represent tangible, concrete improvements to existing technological areas, including, without limitation, weight measurement technology, fishing technology, and/or the like. To the extent any abstract concepts are present in the various embodiments, those concepts can be implemented as described herein by devices, software, systems, and methods that involve specific novel functionality (e.g., steps or operations), such as implementing handheld apparatus-based weight measurement of items that take into account rotation or tilt of the items with respect to the apparatus performing the measurement, handheld apparatus-based weight measurement of items that take into account rotation or tilt of the items with reference to gravitational direction of the Earth, and/or the like, to name a few examples, that extend beyond mere conventional computer processing operations. These functionalities can produce tangible results outside of the implementing computer system, including, merely by way of example, improved measurement of item weight when using a handheld apparatus for measuring weight of items, display or presentation of measured weights, transmission and storage of measured weights, and/or the like, any of which may be observed or measured by users.

In an aspect, a method might comprise measuring, with a weight measurement sensor of a handheld apparatus, a raw signal weight of an item in load-bearing connection with the handheld apparatus, and measuring, with a rotation sensor of the handheld apparatus, at least one of angle of tilt or angle of rotation of the item with respect to at least one of the weight measurement sensor or a handle of the handheld apparatus. The method might also comprise calculating, with a processor of the handheld apparatus, a processed signal weight of the item based at least in part on the measured at least one of angle of tilt or angle of rotation of the item with respect to the at least one of the weight measurement sensor or the handle. The method might further comprise displaying the processed signal weight of the item.

According to some embodiments, the handheld apparatus might comprise one of a handheld fishing net, a fishing rod, a handheld measuring rod, a handheld measuring scale, a handheld item-lifting rod, a shoulder-mounted carrying rod, or a handheld baggage scale, and/or the like. In some cases, the item might comprise one of a fish, a small mammal, a small reptile, a food item, a manufactured item, one or more carrying containers, or a piece of baggage, and/or the like.

In some embodiments, the weight measurement sensor might comprise a load cell selected from a group consisting of a strain gauge load cell, a piezoelectric load cell, a capacitive load cell, a compression load cell, a compression/tension load cell, an S-beam load cell, a bending beam load cell, a platform load cell, a single point load cell, a canister load cell, and a low profile load cell, and/or the like. In some instances, the rotation sensor might comprise one of an accelerometer, a gyroscope, a rotary encoder, an inclinometer, a rotary variable differential transformer, or a tilt sensor, and/or the like. In some cases, measuring the at least one of angle of tilt or angle of rotation of the item might further comprise measuring, with the rotation sensor of the handheld apparatus, at least one of angle of tilt or angle of rotation of the item with reference to gravitational direction of the Earth.

Merely by way of example, in some embodiments, displaying the processed signal weight of the item might comprise displaying, on a display device of the handheld apparatus, the processed signal weight of the item. In some instances, displaying the processed signal weight of the item might comprise sending, with a wireless communications device of the handheld apparatus and to one or more external user devices for display on a display device of at least one of the one or more external user devices, the processed signal weight of the item. The one or more external user devices, according to some embodiments, might comprise at least one of a smart phone, a mobile phone, a smart watch, a personal digital assistant, a tablet computer, a laptop computer, a desktop computer, or a stand-alone display device, and/or the like. The method, in some cases, might further comprise storing, on a data storage device of the handheld apparatus, the processed signal weight of the item.

In another aspect, a handheld apparatus might comprise a weight measurement sensor that is configured to measure a raw signal weight of an item in load-bearing connection with the handheld apparatus and a rotation sensor that is configured to measure at least one of angle of tilt or angle of rotation of the item with respect to at least one of the weight measurement sensor or a handle of the handheld apparatus. The handheld apparatus might also comprise a processor that is configured to calculate a processed signal weight of the item based at least in part on the measured at least one angle of tilt or angle of rotation of the item with respect to the at least one of the weight measurement sensor or the handle. The handheld apparatus might further comprise a display device that is configured to display the processed signal weight of the item.

According to some embodiments, the handheld apparatus might comprise one of a handheld fishing net, a fishing rod, a handheld measuring rod, a handheld measuring scale, a handheld item-lifting rod, a shoulder-mounted carrying rod, or a handheld baggage scale, and/or the like. In some cases, the item might comprise one of a fish, a small mammal, a small reptile, a food item, a manufactured item, one or more carrying containers, or a piece of baggage, and/or the like.

In some embodiments, the weight measurement sensor might comprise a load cell selected from a group consisting of a strain gauge load cell, a piezoelectric load cell, a capacitive load cell, a compression load cell, a compression/tension load cell, an S-beam load cell, a bending beam load cell, a platform load cell, a single point load cell, a canister load cell, and a low profile load cell, and/or the like. In some instances, the rotation sensor might comprise one of an accelerometer, a gyroscope, a rotary encoder, an inclinometer, a rotary variable differential transformer, or a tilt sensor, and/or the like. In some cases, the rotation sensor might be further configured to measure at least one of angle of tilt or angle of rotation of the item with reference to gravitational direction of the Earth.

Merely by way of example, in some embodiments, the handheld apparatus might further comprise a wireless communications device that is configured to send the processed signal weight of the item to one or more external user devices for display on a display device of at least one of the one or more external user devices. The one or more external user devices, according to some embodiments, might comprise at least one of a smart phone, a mobile phone, a smart watch, a personal digital assistant, a tablet computer, a laptop computer, a desktop computer, or a stand-alone display device, and/or the like. The handheld apparatus, in some cases, might further comprise a data storage device that is configured to store the processed signal weight of the item.

In yet another aspect, a weight measurement system for use in conjunction with a handheld apparatus might be provided. The weight measurement system might comprise at least one processor and at least one non-transitory computer readable medium in communication with the at least one processor. The at least one non-transitory computer readable medium might have stored thereon computer software comprising a set of instructions that, when executed by the at least one processor, causes the weight measurement system to perform one or more functions. The set of instructions might comprise instructions for receiving a raw signal weight measurement of an item in load-bearing connection with the handheld apparatus and instructions for receiving at least one of a measured angle or a measured rotation of the item with respect to at least one of a weight measurement sensor or a handle of the handheld apparatus. The set of instructions might also comprise instructions for calculating a processed signal weight of the item based at least in part on the at least one of the measured angle or the measured rotation of the item with respect to the at least one of the weight measurement sensor or the handle. The set of instructions might further comprise instructions for sending the processed signal weight of the item for display on a display device.

Various modifications and additions can be made to the embodiments discussed without departing from the scope of the invention. For example, while the embodiments described above refer to particular features, the scope of this invention also includes embodiments having different combination of features and embodiments that do not include all of the above described features.

In some aspects, a fishing net might comprise a handle and a basket made of a net material for catching fish. Within the handle is disposed electronic circuitry and sensors to detect the force the object in the basket exerts with respect to the handle due to the force of gravity. The electronic circuity can also process the data into meaningful representations, such as weight to be shown on a display (which may also be disposed within the handle).

According to some embodiments, the fishing net might include load cells (e.g., strain gauges, or the like) that are mounted to the inside wall of the handle toward the basket-end. These sensors translate force into electronic signals that are then amplified so that they can be detected by a microprocessor unit (“MCU”). The MCU translates the signal into values such as weight to be shown on a display for the user. The unit, in some embodiments, might be powered by one or more batteries (for example, but not limited to, 2 AA batteries in series, or the like). In addition to the above-mentioned circuitry, other electronics may be incorporated to provide additional functionalities. For example, because the fishing net may be held at angles other than parallel to the Earth's gravitational pull, it is necessary to compensate for that deviation on the sensors. In some embodiments, this may be accomplished by using an accelerometer (or other suitable rotation sensor) to calculate angle and to scale the results of the sensors accordingly. Offset circuitry may also exist to null, dismiss, or ignore any undesired measured force by the strain gauges. The user, in some instances, can also tare the device at any time using a button. In some cases, the user can also instruct the fishing net to store weights for future reference.

In some embodiments, the fishing net may also include a wireless communications circuit to send data to another device (i.e., external device) such as a mobile smart phone, a tablet, and/or any other suitable user device. In most embodiments, all electronics are housed in the handle, which is made to be waterproof and buoyant.

### Specific Exemplary Embodiments

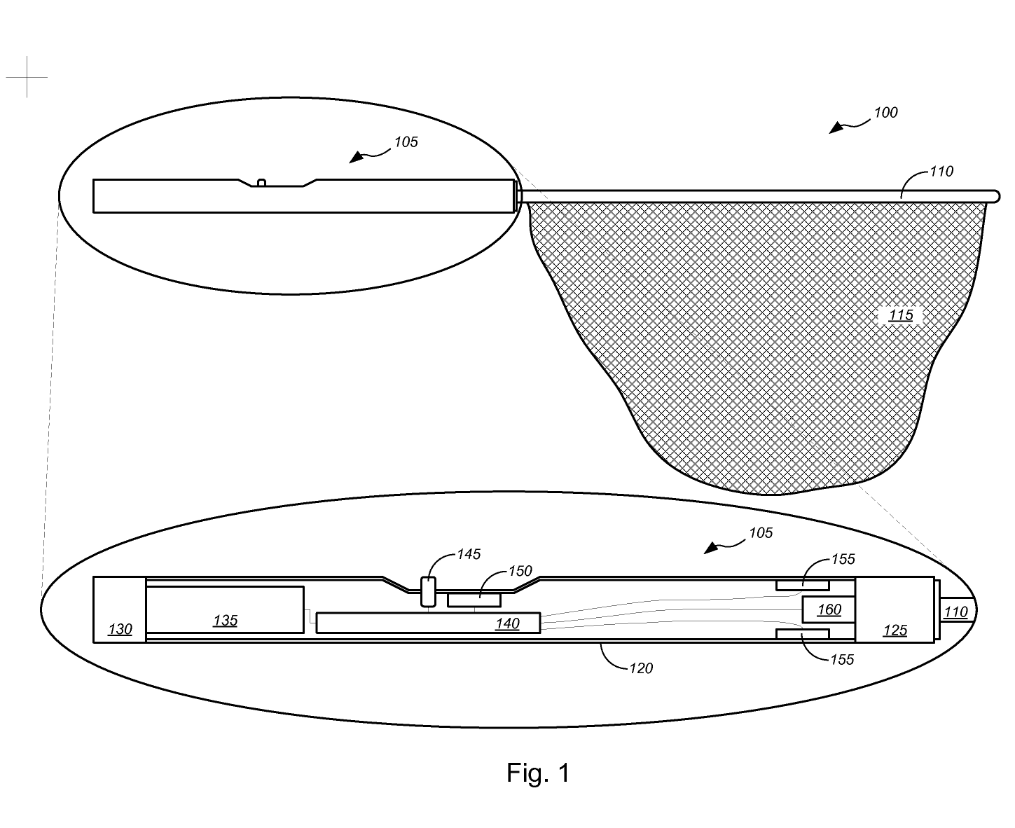

We now turn to the embodiments as illustrated by the drawings. FIGS. 1-7 illustrate some of the features of the method, system, and apparatus for implementing electronic weight measurement using a handheld apparatus (e.g., fishing net or other handheld apparatus) that, in some cases, takes into account measurement deviations due to rotational, tilt, or angular orientation of the handheld apparatus during measurement, as referred to above. The methods, systems, and apparatuses illustrated by FIGS. 1-7 refer to examples of different embodiments that include various components and steps, which can be considered alternatives or which can be used in conjunction with one another in the various embodiments. The description of the illustrated methods, systems, and apparatuses shown in FIGS. 1-7 is provided for purposes of illustration and should not be considered to limit the scope of the different embodiments.

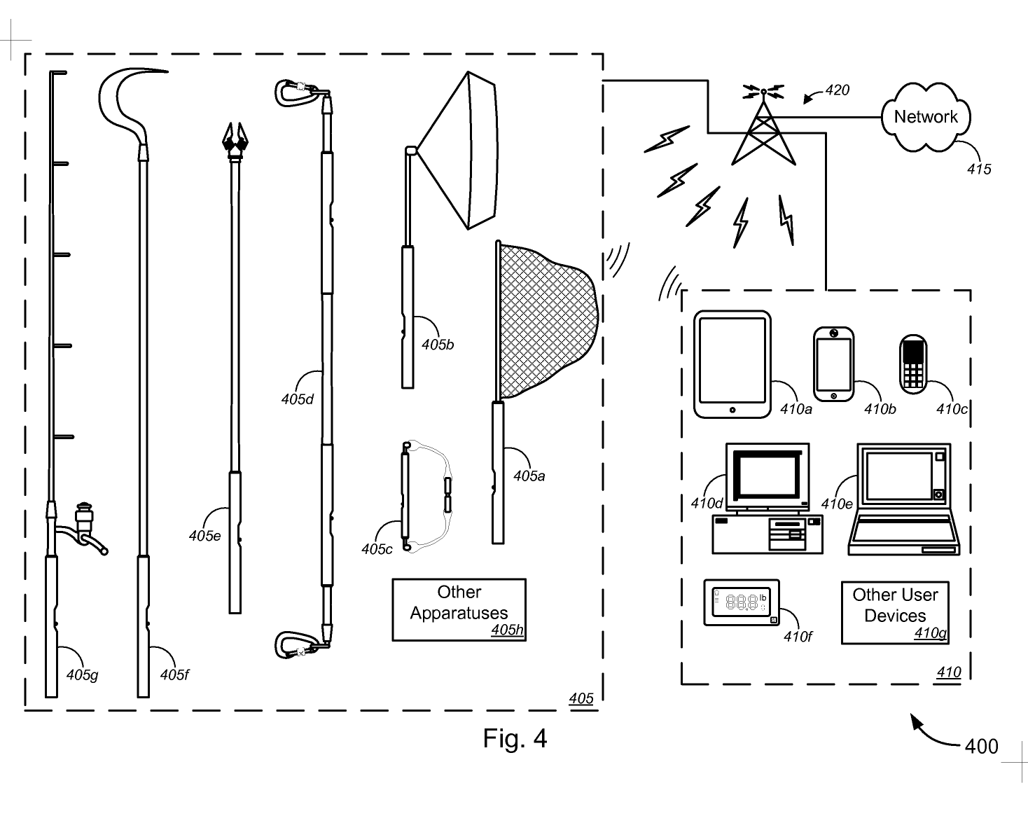

With reference to the figures, FIG. 1 is a schematic diagram illustrating an exemplary handheld apparatus 100 for implementing electronic weight measurement, in accordance with various embodiments. Although the handheld apparatus shown in FIG. 1 is a handheld fishing net, the various embodiments are not so limited, and the handheld apparatus may be any suitable handheld apparatus including, but without limitation, a fishing rod, a handheld measuring rod, a handheld measuring scale, a handheld item-lifting rod, a shoulder-mounted carrying rod, a handheld baggage scale, and/or the like, some of which are shown and described below with respect to FIG. 4.

In some embodiments, the handheld apparatus 100 might include, without limitation, a handle or handle portion 105 and a functional or load-bearing portion 110. In the embodiment of FIG. 1, the handheld apparatus 100 is a handheld fishing net. Accordingly, the functional or load-bearing portion 110 includes a net 115 affixed to the functional or load-bearing portion 110.

FIG. 1 also depicts a blown-up schematic view of the handheld apparatus 100, with a partial cut-out or sectional view of the handle 105 and of the connection with the functional or load-bearing portion 110. In particular, as shown in FIG. 1, the handle 105 of the handheld apparatus 100 includes, without limitation, at least one or more of a housing 120, a first end-cap 125, a second end-cap 130, a power supply compartment 135, a circuit component 140, one or more input devices 145, a display device 150, one or more weight measurement sensors 155, one or more rotation sensors 160, and/or the like. In some cases, first end-cap 125 might attach to, or couple with, the functional or load-bearing portion 110. In some embodiments, the second end-cap 130 may be removably affixed to the housing 120, in some cases via threaded connection or the like. The second end-cap 130 might, in some instances, provide access to the power supply compartment 135 (which, in some cases, might house one or more batteries, other power supplies, or the like). In some cases, the one or more batteries might include, without limitation, one of one or more AAA batteries, one or more AA batteries, one or more C batteries, one or more D batteries, one or more 9V batteries, one or more other suitable batteries, and/or the like. The one or more batteries might be of a type including, but not limited to, alkaline, carbon-zinc, Li—FeS₂, NiMH, NiCd, NiOOH, Lithium ion, and/or the like, and may be rechargeable or one-use types, or the like. In some embodiments in which rechargeable batteries are implemented, the handheld apparatus might implement inductive or other wireless charging (not shown) to recharge the rechargeable batteries. In other embodiments, the batteries may be replaced or recharged by removing the second end-cap 130 to access the power supply compartment 135.

In some embodiments, the circuit component 140 might include one or more processors, one or more data storage devices, one or more display device interfaces, one or more input device interfaces, one or more weight measurement sensor interfaces, one or more rotation sensor interfaces, one or more power supply interfaces, and/or the like. In some cases, the circuit component 140 might be embodied as one or more printed circuit board components, and/or the like. According to some embodiments, the one or more input devices might include, without limitation, at least one of one or more physical buttons, one or more virtual (or touch screen) buttons, one or more dials, one or more switches, one or more microphones, and/or the like that are configured to receive user input for commands for functions, including, but not limiting to, one or more of taring weight of the handheld apparatus, saving or storing a weight of an item or object being measured, selecting metric or imperial measurements (i.e., (kilo)grams (g or kg) or pounds (lbs.), and/or the like), turning on/off the weight measurement, turning on/off rotation or angle sensing, turning on/off calculation of processed signal weight based on rotation, tilt, or angular sensing, selecting devices to send measured/calculated weights of items, and/or the like. In some instances, the display device 150 might include at least one touchscreen display device and/or at least one non-touchscreen display device, each of which might be of a display type including, without limitation, one of a liquid crystal display (“LCD”), a light emitting diode (“LED”) display, an organic LED (“oLED”) display, and/or the like.

According to some embodiments, the one or more weight measurement sensors 155 might each include, without limitation, a load cell selected from a group consisting of a strain gauge load cell, a piezoelectric load cell, a capacitive load cell, a compression load cell, a compression/tension load cell, an S-beam load cell, a bending beam load cell, a platform load cell, a single point load cell, a canister load cell, and/or a low profile load cell, or the like. In some cases, each of the one or more weight measurement sensors 155 might be mounted on, or otherwise coupled to, an interior wall of the housing 120; mounted on, or otherwise coupled to, an inward-facing wall (with respect to an interior of the housing 120) of the first end-cap 125 (not shown); disposed within, or otherwise constructed as part of, the first end-cap 125 (not shown); and/or the like. In some embodiments, the one or more rotation sensors 160 might include, but is not limited to, one of an accelerometer, a gyroscope, a rotary encoder, an inclinometer, a rotary variable differential transformer, a tilt sensor, and/or the like. In some instances, each of one or more rotation sensors 160 might be mounted on, or otherwise coupled to, an interior wall of the first end-cap 125; mounted on, or otherwise coupled to, an interior wall of the housing 120 (not shown); mounted on, or otherwise coupled to, the circuit component 140 (not shown); disposed within, or otherwise constructed as part of, the first end-cap 125 (not shown); and/or the like.

For a number of implementations, such as for fishing nets, fishing rods, and/or the like, it is intended that the handheld apparatus be used near or in water, and thus, the housing 120, the first end-cap 125, the second end-cap 130, the input device(s) 145, and the display device 150, and interconnecting components (e.g., seals, grommets, connectors, and/or the like) are designed to be made of resilient, waterproof material and are configured so as to provide water-tightness when assembled together. In some cases, at least the housing 120 is made to be buoyant, to ensure that the apparatus 100 floats in water (i.e., does not sink).

In operation, taking for example the case of the handheld apparatus 100 being a fishing net, after a user catches a fish (e.g., bass, trout, salmon, etc.) using a fishing rod or fishing pole, the fishing net itself, or the like, the user (or another user) might scoop the fish within the net 115 (either above water or under water, or a combination of these). The user (or other user) might turn on or otherwise activate the weight measurement sensor(s) 155 or weight measurement sensor functionality. In some cases, the rotation sensor(s) 160 might automatically sense rotation and/or tilt of the handheld apparatus with respect to the direction of gravity (i.e., gravitational direction of the Earth), and/or rotation and/or tilt of the fish with respect to the weight measurement sensor 155 and/or the handle 105. The processor(s) might calculate the processed (or actual) weight of the fish based at least in part on the measured initial or raw signal weight of the fish and on the measured rotation or tilt (of the handheld apparatus with respect to the direction of gravity and/or of the fish with respect to the weight measurement sensor 155 and/or the handle 105), and might cause the display 150 to display the processed (or actual) weight of the fish. In alternative embodiments, the user might activate the rotation sensor 160, which might also trigger the calculation and display functions. In this manner, any deviation in the weight measurement sensor readings due to a deviation in orientation from alignment with the direction of gravity (i.e., due to tilt or rotation of the handheld apparatus) may be compensated for, or otherwise taken into account. In some cases, it may be difficult to hold the fish (especially a heavy one) in a particular orientation for any amount of time necessary to ensure accurate weight measurement. The handheld apparatus and the techniques described above allow for a more natural use or ease of use of the weight measurement functionality, while ensuring accuracy in measurement.

In some embodiments, the user (or other user) might tare the weight (i.e., zero the weight measurement) prior to scooping up the fish within the net 115. The user (or other user) might, in some cases, store or save a weight measurement, and might, in some instances, select a wireless device or other user device (herein referred to as “external device” or “external devices”) to wirelessly send one or more stored or saved weight measurements. The one or more external devices might, in some instances, include, but are not limited to, at least one of a smart phone, a mobile phone, a smart watch, a personal digital assistant, a tablet computer, a laptop computer, a desktop computer, a stand-alone display device, and/or the like. The user (or other user) may also choose between metric and imperial measurements (i.e., between g (or kg) and lbs.) with the push (or actuation/activation) of a button or switch, or the like.

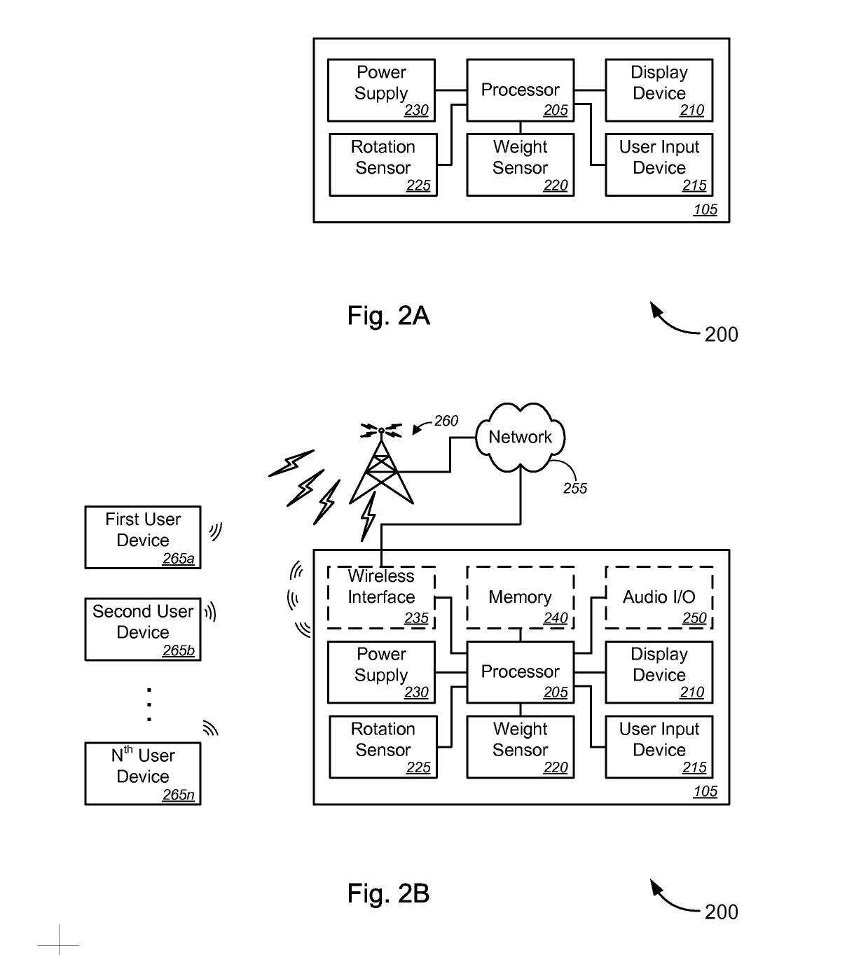

FIGS. 2A and 2B (collectively, “FIG. 2”) are schematic block diagrams illustrating various systems 200 for implementing electronic weight measurement using a handheld apparatus, in accordance with various embodiments. FIG. 2A depicts an embodiment of the handheld apparatus that is configured to measure weight and rotation/tilt, to perform calculations of actual or processed weight that takes into account rotation/tilt or the like, to receive user inputs, and to display weight measurements, as described in detail above with respect to FIG. 1. FIG. 2B depicts an embodiment of the handheld apparatus that has the same functionalities as the embodiment of FIG. 2A, and is further configured to allow for storing or saving weight measurements (and external device information), to allow for audio input and/or output, to allow for wireless interface with external devices and/or networks, etc.

In the embodiment of FIG. 2, the handle 105 of apparatus 100 might include, without limitation, one or more processors 205, one or more display devices 210, one or more user input devices 215, one or more weight sensors 220, one or more rotation sensors 225, one or more power supplies 230, and/or the like. The one or more display devices 210, the one or more user input devices 215, the one or more weight sensors 220, the one or more rotation sensors 225, and the one or more power supplies 230 might each communicatively couple with the one or more processors 205. In some cases, the one or more power supplies 230 might also provide electrical power to at least one of the one or more display devices 210, the one or more user input devices 215, the one or more weight sensors 220, and the one or more rotation sensors 225. In some embodiments, the one or more display devices 210, the one or more user input devices 215, the one or more weight sensors 220, and the one or more rotation sensors 225 might generally correspond to the display device 150, the one or more input devices 145, the one or more weight measurement sensors 155, and the one or more rotation sensors 160 of FIG. 1, respectively. The one or more processors 205 might be included within the circuit component 140 of FIG. 1, while the one or more power supplies 230 might be housed within the power supply compartment 135 of FIG. 1. In some instances, the one or more power supplies 230 might include one or more batteries, other power supplies, or the like. The one or more batteries, according to some embodiments, might include, without limitation, one of one or more AAA batteries, one or more AA batteries, one or more C batteries, one or more D batteries, one or more 9V batteries, one or more other suitable batteries, and/or the like. The one or more batteries might be of a type including, but not limited to, alkaline, carbon-zinc, Li—FeS₂, NiMH, NiCd, NiOOH, Lithium ion, and/or the like, and may be rechargeable or one-use types, or the like. In some embodiments in which rechargeable batteries are implemented, the handheld apparatus might implement inductive or other wireless charging (not shown) to recharge the rechargeable batteries.

With reference to the FIG. 2B, system 200 might include an apparatus, the handle 105 of which includes, without limitation, one or more processors 205, one or more display devices 210, one or more user input devices 215, one or more weight sensors 220, one or more rotation sensors 225, one or more power supplies 230, and at least one of one or more (optional) wireless interface devices 235, one or more (optional) memory or data storage devices 240, or one or more audio input and/or output devices 250, or the like. The one or more display devices 210, the one or more user input devices 215, the one or more weight sensors 220, the one or more rotation sensors 225, the one or more power supplies 230, and the at least one of one or more (optional) wireless interface devices 235, one or more (optional) memory or data storage devices 240, or one or more audio input and/or output devices 250 might each communicatively couple with the one or more processors 205. In some cases, the one or more power supplies 230 might also provide electrical power to at least one of the one or more display devices 210, the one or more user input devices 215, the one or more weight sensors 220, the one or more rotation sensors 225, the one or more (optional) wireless interface devices 235, the one or more (optional) memory or data storage devices 240, and/or the one or more audio input and/or output devices 250. In some embodiments, system 200 might further comprise one or more networks 255, one or more telecommunications relay systems 260, and one or more user devices 265, or the like.

The one or more networks 255 might each include any suitable network, including, but not limited to, a local area network (“LAN”), including, without limitation, a fiber network, an Ethernet network, a Token-Ring™ network and/or the like; a wide-area network (“WAN”); a wireless wide area network (“WWAN”); a virtual network, such as a virtual private network (“VPN”); the Internet; an intranet; an extranet; a public switched telephone network (“PSTN”); an infra-red network; a wireless network, including, without limitation, a network operating under any of the IEEE 802.11 suite of protocols, the Bluetooth™ protocol known in the art, and/or any other wireless protocol; or any combination of these and/or other networks. The one or more telecommunications relay systems 260 might include, without limitation, one or more wireless network interfaces (e.g., wireless modems, wireless access points, and the like), one or more towers, one or more satellites, and/or the like. The one or more user devices 265 might include a first user device 265a, a second user device 265b, through an N^{th} user device 265n, and might generally correspond to the one or more external devices (described above), which might, in some instances, include, but are not limited to, at least one of a smart phone, a mobile phone, a smart watch, a personal digital assistant, a tablet computer, a laptop computer, a desktop computer, a stand-alone display device, and/or the like.

In some embodiments, the one or more wireless interface devices 235 (in some cases, referred to as “wireless communications device” or the like) might communicatively couple with at least one of the one or more user devices 265 either directly, indirectly via a combination of at least one the network 255 and at least one telecommunications relay system 260, indirectly via at least one telecommunications relay system 260, and/or the like. In some cases, the one or more wireless interface devices 235 might additionally include wired connectivity functionality to allow at the handheld apparatus to communicate in a wired fashion with at least one user device 265.

According to some embodiments, the one or more memory or data storage devices 240 might be any suitable tangible or physical memory device including, without limitation, a RAM chip, a PROM chip, an EPROM chip, a FLASH-EPROM chip, and/or the like. The one or more memory or data storage devices 240 might store one or more weight measurements of items (including raw signal weight and/or processed signal weight), and, in some cases, might also store device identification information for one or more user devices 265, network identification information for one or more networks 255, authentication information of the user for communicating with at least one user device 265 and/or with at least one network 255, and/or the like.

In some aspects, the one or more audio input and/or output devices 250 might include, without limitation, at least one of one or more microphones, one or more speakers, and/or the like. The one or more microphones might allow for user voice input for controlling the functionalities of the handheld device, including, but not limited to taring weight of the handheld apparatus, saving or storing a weight of an item or object being measured, selecting metric or imperial measurements (i.e., (kilo)grams (g or kg) or pounds (lbs.), and/or the like), turning on/off the weight measurement, turning on/off rotation or angle sensing, turning on/off calculation of processed signal weight based on rotation, tilt, or angular sensing, selecting devices to send measured/calculated weights of items, and/or the like. The one or more speakers might allow for audio presentation of options for prompting user selection of functionalities, for audio presentation of the raw signal and/or processed signal weights of items, for audio presentation of options for connecting with one or more user devices 265, and/or the like.

In some embodiments, the system 200 might include an apparatus, the handle 105 of which includes, without limitation, one or more processors 205, one or more display devices 210, one or more user input devices 215, one or more weight sensors 220, one or more rotation sensors 225, one or more power supplies 230, and at least one of a clock (not shown) and/or a location determination device (not shown), or the like. In some cases, the handle 105 might further include at least one of one or more (optional) wireless interface devices 235, one or more (optional) memory or data storage devices 240, or one or more audio input and/or output devices 250, or the like. The clock may be independently operated on the apparatus 100, and/or may (in some cases) be updated when synchronized with an external clock (e.g., clock on a user device 265, an atomic clock, etc.) via network(s) 255, telecommunications relay system(s) 260, and/or user device(s) 265, or the like. The location determination device might include a global positioning system (“GPS”), position triangulation systems, and/or the like. In some cases, the location determination device might simply receive location information about the location of the apparatus 100 (or handle 105 thereof) from external sources (e.g., user devices 265, telecommunications relay systems 260, networks 255, etc.).

In operation, when displaying (on display device 210), storing (in the memory or data storage device 240), or sending (to at least one user device 265 either directly or via network(s) 255 and/or telecommunications relay system 260) the raw signal weight and/or the processed signal weight (which takes into account rotation and/or tilt) of an item being measured, additional information including, without limitation, time, date, and position information may also be displayed, stored, or sent in conjunction with the weight measurements. In this manner, the user may be provided a detailed record of where and when particular weight measurements are tracked. Merely by way of example, the user input device 215 and/or the audio input device 250 might allow the user to input by button selection, touchscreen selection, voice input, or the like the item that is being weighed. As a result, the detailed record might include one or more of item information, raw signal weight, processed signal weight, time and date of measurement, location, and/or the like.

In some cases, the rotation and/or tilt information may also be tracked, to allow the user to track ergonomic positions when lifting/measuring weights of items. For example, if a person who fishes a lot might be interested to know whether how he or she is holding a fishing net while weighing fish may lead to wrist issues (e.g., carpal tunnel syndrome or the like) or other physical injury(ies) or strain(s); the rotation and/or tilt information, as well as weight measurement information, may be used by ergonomic tracking apps or the like on one or more user devices that might utilize stored physical measurements of the user (e.g., height, weight, arm length, etc.) in combination with the rotation and/or tilt information, the weight measurement information, and other relevant information to evaluate whether persistent holding an item of the measured (or average) weight at the measured (or average) rotation and/or tilt of the apparatus for someone of the height, weight, arm length, etc. of the particular user might eventually lead to injury.

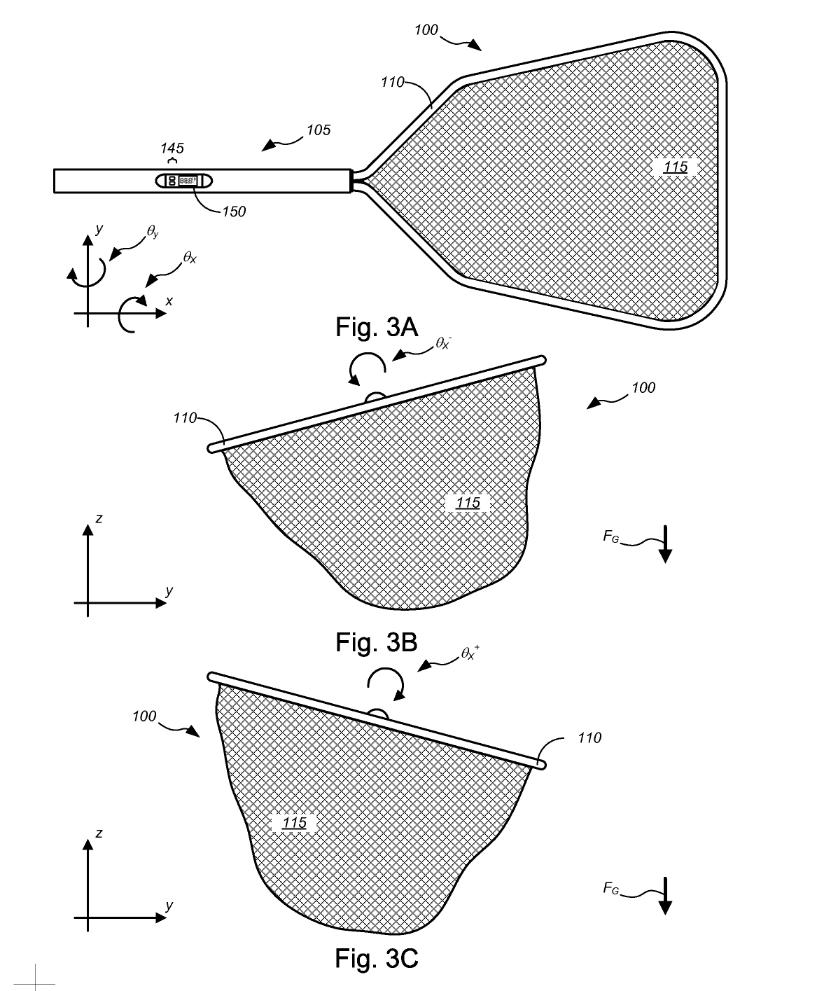

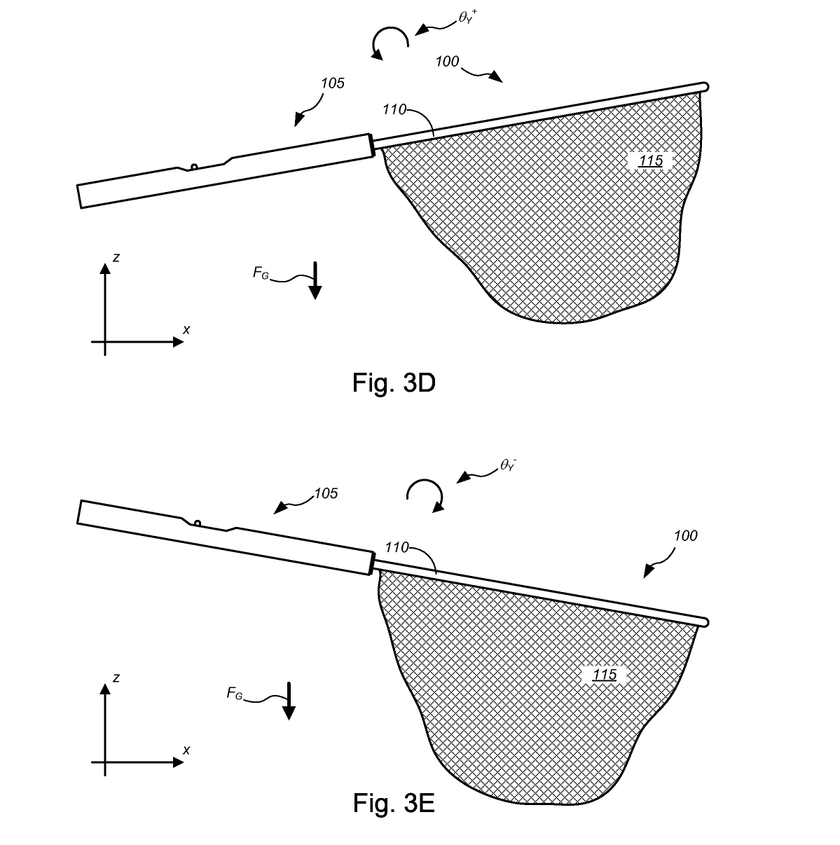

FIGS. 3A-3E (collectively, “FIG. 3”) are schematic diagrams illustrating various rotational, tilt, or angular orientations of an exemplary handheld apparatus 100 that are taken into account when implementing electronic weight measurement, in accordance with various embodiments. As with FIG. 1 above, although the handheld apparatus shown in FIG. 3 is a handheld fishing net, the various embodiments are not so limited, and the handheld apparatus may be any suitable handheld apparatus including, but without limitation, a fishing rod, a handheld measuring rod, a handheld measuring scale, a handheld item-lifting rod, a shoulder-mounted carrying rod, a handheld baggage scale, and/or the like, some of which are shown and described below with respect to FIG. 4.

In FIG. 3, the x, y, and z axes are shown (two of three of which are shown in each of FIGS. 3A-3E) to provide perspective with respect to tilt and rotation with respect to the direction of gravity (depicted by the thick arrow denoted “F_{G}” in FIGS. 3B-3E) that is parallel with the z-axis. FIG. 3A depicts a top view of an exemplary handheld fishing net 100, as described in detail above with respect to FIG. 1. FIGS. 3B and 3C depict rotation about the x-axis (which is parallel with an axis of the handle 105, and which is along a direction parallel with a plane defined by the y-z axes) in the clockwise or negative x-axis (“θₓ⁻”) direction (FIG. 3B) or in the counter-clockwise or positive x-axis (“θₓ⁺”) direction (FIG. 3C), both with respect to perspective of a user holding the handheld apparatus. FIGS. 3D and 3E depict tilt about the y-axis (which is perpendicular with an axis of the handle 105, and which is along a direction parallel with a plane defined by the x-z axes) in the up-tilt or positive y-axis (“θ_{y}⁺”) direction (FIG. 3D) or in the down-tilt or negative y-axis (“θ_{y}⁻”) direction (FIG. 3E), both with respect to perspective of a user holding the handheld apparatus. Herein, although both are referring to rotation about one of the axes (and, in some cases, may be synonymous or interchangeable), “rotation” is used to refer to rotation about the x-axis, while “tilt” is used to refer to rotation about the y-axis.

As described in detail above with respect to FIGS. 1 and 2, these rotations and tilts (or angles of rotation and/or angles of tilt) are measured or detected by rotation sensor(s) 160 or 225, and such measurements of (angles of) rotation and tilt are taken into account when calculating processed signal weights of items or objects.

FIG. 4 is a schematic diagram illustrating various embodiments of a system 400 for implementing electronic weight measurement using a handheld apparatus. As shown in the embodiment of FIG. 4, system 400 might comprise one or more handheld apparatuses 405, one or more user devices 410, and, in some cases, a network 415 and/or one or more telecommunications relay systems 420. The one or more handheld apparatuses 405 might correspond to handheld apparatus 100 in FIGS. 1-3, while the one or more user devices 410 might correspond to the one or more user devices 265 of FIG. 2B, the network 415 might correspond to the one or more networks 255 of FIG. 2B, and the one or more telecommunications relay systems 420 might correspond to the one or more telecommunications relay systems 260 also of FIG. 2B.

In some embodiments, the one or more handheld apparatuses 405 might include, without limitation, a handheld fishing net 405a, a handheld measuring scale 405b, a handheld baggage scale 405c, a shoulder-mounted carrying rod 405d, a handheld measuring rod 405e, a handheld item-lifting rod 405f, a handheld fishing rod or pole 405g, and one or more other apparatuses 405h. The handheld fishing net 405a is as described in detail above with respect to FIGS. 1 and 3. Each of the handheld measuring scale 405b, the handheld baggage scale 405c, the shoulder-mounted carrying rod 405d, the handheld measuring rod 405e, the handheld item-lifting rod 405f, the handheld fishing rod or pole 405g, and the one or more other apparatuses 405h has a handle and/or a functional or load-bearing portion that are similar, if not identical, to the handle 105 as described above with respect to FIGS. 1-3.

In some cases, the handheld measuring scale 405b might have a pivot attachment at the distal end of the functional or load-bearing portion that allows the loading tray (which is affixed to the pivot attachment via three or four strings, ropes, lines, etc.) to pivot with respect to the functional or load-bearing portion (and with respect to the handle). This allows the loading tray to generally remain parallel with a plane that is perpendicular to the direction of gravity (i.e., plane parallel with the plane defined by the x-y axes in FIG. 3A, for example), regardless of the rotation and/or tilt of the handheld measuring scale 405b. In some embodiments, each of the handheld baggage scale 405c and the shoulder-mounted carrying rod 405d might have a similar pivot attachment at each end of the apparatus.

According to some embodiments, the handheld baggage scale 405c might have weight measure sensors and rotation sensors on one end of the apparatus, while the other end is merely affixed to the strap for balance and for ease of use of the baggage scale. In some instances, buckles, clips, clasps, or other suitable releasable couplers might be used to releasably connect two straps together to easily clip around a handle of a baggage, luggage, other bag, or the like.

In some embodiments, the shoulder-mounted carrying rod 405d might include two handle portions (each handle portion generally corresponding to handle portion 105 of FIGS. 1-3 above, or the like) connected by a resilient rod or pole, which, in some cases, has a rubber or other resilient padding to allow for comfortable use of the shoulder-mounted carrying rod. Although FIG. 4 depicts the shoulder-mounted carrying rod 405d as having carabiners, the various embodiments are not so limited, and the shoulder-mounted carrying rod 405d may have any attachment at the ends thereof including, but not limited to, carabiners, hooks, grabbers, etc. In addition, the shoulder-mounted carrying rod 405d can have the same or different attachments on both ends. In some cases, the attachments may be permanently fixed or may be removably affixed to the ends of the shoulder-mounted carrying rod 405d. In a similar manner, in some cases, each of the handheld measuring rod 405e and the handheld item-lifting rod 405f might have a permanently fixed or removably affixed attachment, which includes, without limitation, carabiners, hooks, grabbers, or the like. In some instances, each of the shoulder-mounted carrying rod 405d, the handheld measuring rod 405e, and the handheld item-lifting rod 405f may be used to carry water buckets, containers, baggages, food items, fruits, construction materials, fish, small mammals, small reptiles, manufactured items, rocks, plants, gravel, wood, or other suitable item or object, and/or the like.

According to some embodiments, the handheld fishing rod or pole 405g might be similar to any existing fishing rod or pole, except that the handle portion is similar or identical to handle 105 as described above with respect to FIGS. 1-3. In some cases, the one or more other apparatuses 405h might include, for example, a handheld weight-measuring bassinet for carrying and weighing babies, or any other suitable handheld device that is used for carrying items.

The one or more user devices 410, as shown in the embodiment of FIG. 4, might include, without limitation, a tablet computer 410a, a smart phone 410b, a mobile phone 410c, a desktop computer 410d, a laptop computer 410e, a stand-alone display device 410f, and/or other user device 410g. The other user device 410g might include, but is not limited to, a smart watch, a personal digital assistant, a control or display panel of a vehicle, and/or the like. As described in detail above (with respect to user devices 265 or the like), the one or more handheld apparatuses 405 might communicate wirelessly with the one or more user devices 410 either directly, indirectly via a combination of at least one the network 415 and at least one telecommunications relay system 420, indirectly via at least one telecommunications relay system 420, and/or the like. In this manner, information including, without limitation, raw signal weight measurements, processed signal weight measurements (that take into account rotation and/or tilt of the apparatus or item, etc.), device identification information for one or more user devices 265, network identification information for one or more networks 255, authentication information of the user for communicating with at least one user device 265 and/or with at least one network 255, and/or the like may be exchanged between an apparatus 405 and a user device 410.

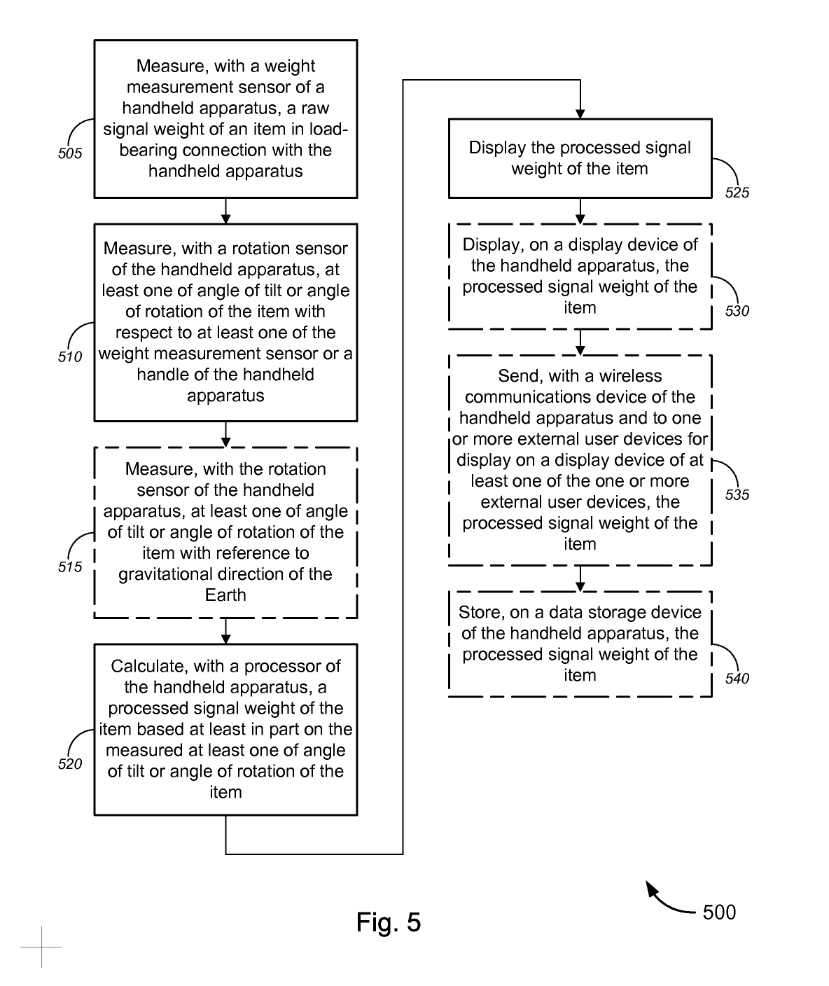

FIG. 5 is a flow diagram illustrating a method 500 for implementing electronic weight measurement using a handheld apparatus, in accordance with various embodiments. The embodiments as represented in FIG. 5 are merely illustrative and are not intended to limit the scope of the various embodiments. While the techniques and procedures are depicted and/or described in a certain order for purposes of illustration, it should be appreciated that certain procedures may be reordered and/or omitted within the scope of various embodiments. Moreover, while the method illustrated by FIG. 5 can be implemented by or with (and, in some cases, are described below with respect to) the apparatuses/systems 100-400 of FIGS. 1-4, respectively (or components thereof), such methods may also be implemented using any suitable hardware implementation. Similarly, while each of the apparatuses/systems 100-400 (and/or components thereof) of FIGS. 1-4, respectively, can operate according to the method illustrated by FIG. 5 (e.g., by executing instructions embodied on a computer readable medium), the systems 100-400 can each also operate according to other modes of operation and/or perform other suitable procedures.

In the embodiment of FIG. 5, method 500, at block 505, might comprise measuring, with a weight measurement sensor of a handheld apparatus, a raw signal weight of an item in load-bearing connection with the handheld apparatus. In some embodiments, the handheld apparatus might include, without limitation, one of a handheld fishing net, a fishing rod, a handheld measuring rod, a handheld measuring scale, a handheld item-lifting rod, a shoulder-mounted carrying rod, a handheld baggage scale, and/or the like. In some cases, the item include, but is not limited to, one of a fish, a small mammal, a small reptile, a food item, a manufactured item, one or more carrying containers, a piece of baggage, and/or the like. In some instances, the handheld apparatus might be a handheld weight-measuring bassinet, which might be used to weigh a baby. According to some embodiments, the weight measurement sensor might include, without limitation, a load cell selected from a group consisting of a strain gauge load cell, a piezoelectric load cell, a capacitive load cell, a compression load cell, a compression/tension load cell, an S-beam load cell, a bending beam load cell, a platform load cell, a single point load cell, a canister load cell, and/or a low profile load cell, or the like.

At block 510, method 500 might comprise measuring, with a rotation sensor of the handheld apparatus, at least one of angle of tilt and/or angle of rotation of the item with respect to at least one of the weight measurement sensor and/or a handle of the handheld apparatus. In some embodiments, the rotation sensor might include, but is not limited to, one of an accelerometer, a gyroscope, a rotary encoder, an inclinometer, a rotary variable differential transformer, a tilt sensor, and/or the like. Method 500, at optional block 515, might, according to some embodiments, comprise measuring, with the rotation sensor of the handheld apparatus, at least one of angle of tilt and/or angle of rotation of the item with reference to gravitational direction of the Earth.

Method 500 might further comprise, at block 520, calculating, with a processor of the handheld apparatus, a processed signal weight of the item based at least in part on the measured at least one of angle of tilt and/or angle of rotation of the item with respect to the at least one of the weight measurement sensor or the handle. At block 525, method 500 might comprise displaying the processed signal weight of the item, which might include, without limitation, one of displaying, on a display device of the handheld apparatus, the processed signal weight of the item (optional block 530) or sending, with a wireless communications device of the handheld apparatus and to one or more external user devices for display on a display device of at least one of the one or more external user devices, the processed signal weight of the item (optional block 535), and/or the like. Merely by way of example, in some embodiments, the one or more external user devices might include, but is not limited to, at least one of a smart phone, a mobile phone, a smart watch, a personal digital assistant, a tablet computer, a laptop computer, a desktop computer, a stand-alone display device, and/or the like.

Method 500, at optional block 540, might comprise storing, on a data storage device of the handheld apparatus, the processed signal weight of the item. Although method 500 is directed to optionally sending or storing the processed signal weight of the item, other information (including, without limitation, one or more of raw signal weight, information about the item being measured (e.g., voice or entered user input indicating name of item, notes about the item, or the like), date, time, location, angle of tilt, angle of rotation, and/or the like) may also be sent or stored.

Exemplary System and Hardware Implementation

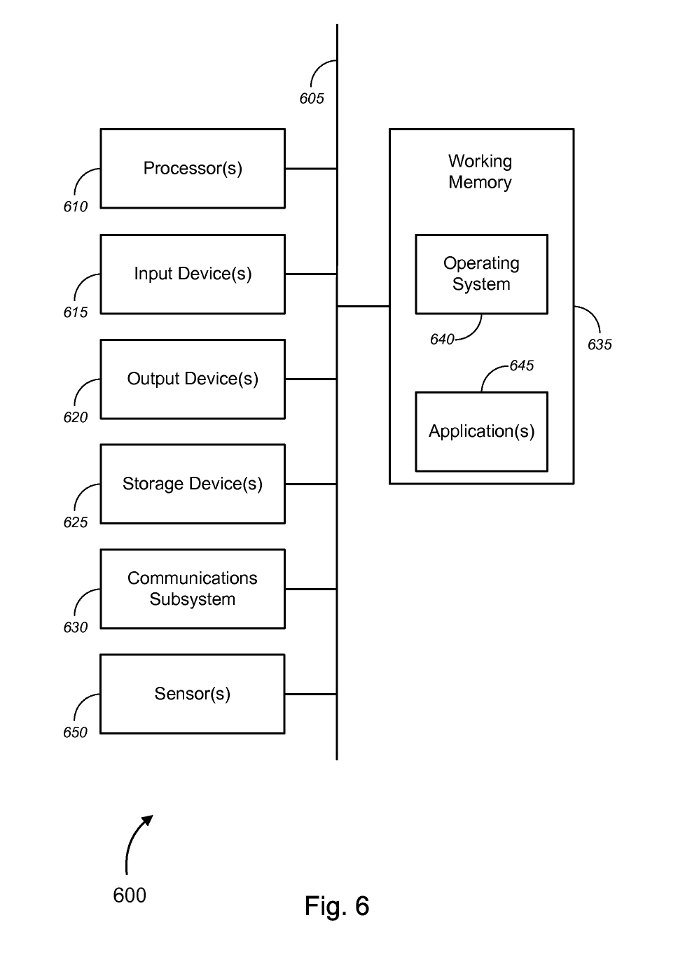

FIG. 6 is a block diagram illustrating an exemplary computer or system hardware architecture, in accordance with various embodiments. FIG. 6 provides a schematic illustration of one embodiment of a computer system 600 of hardware of an apparatus that can perform the methods provided by various other embodiments, as described herein, and/or can perform the functions of apparatuses 100, 105, and/or 405, systems 200 and/or 400, and/or user devices or computing systems 265 and/or 410, or the like, as described above. It should be noted that FIG. 6 is meant only to provide a generalized illustration of various components, of which one or more (or none) of each may be utilized as appropriate. FIG. 6, therefore, broadly illustrates how individual system elements may be implemented in a relatively separated or relatively more integrated manner.

The computer or hardware system 600—which might represent an embodiment of the apparatuses 100, 105, and/or 405, systems 200 and/or 400, and/or user devices or computing systems 265 and/or 410, or of any other device, as described above with respect to FIGS. 1-5—is shown comprising hardware elements that can be electrically coupled via a bus 605 (or may otherwise be in communication, as appropriate). The hardware elements may include one or more processors 610, including, without limitation, one or more general-purpose processors and/or one or more special-purpose processors (such as digital signal processing chips, graphics acceleration processors, and/or the like); one or more input devices 615, which can include, without limitation, a touchscreen display, one or more buttons, a keypad, a microphone, and/or the like (in the case of the apparatuses), or a touchscreen display, a keypad, a microphone, a mouse, a keyboard, and/or the like (in the case of the user devices or computing systems); and one or more output devices 620, which can include, without limitation, a display device, a speaker, an indicator light system, and/or the like (in the case of the apparatuses), or a display device, a speaker, an indicator light system, a printer, and/or the like (in the case of the user devices or computing systems).

The computer or hardware system 600 may further include (and/or be in communication with) one or more storage devices 625, which can comprise, without limitation, local and/or network accessible storage, and/or can include, without limitation, a disk drive, a drive array, an optical storage device, solid-state storage device such as a random access memory (“RAM”) and/or a read-only memory (“ROM”), which can be programmable, flash-updatable, and/or the like. Such storage devices may be configured to implement any appropriate data stores, including, without limitation, various file systems, database structures, and/or the like.

The computer or hardware system 600 might also include a communications subsystem 630, which can include, without limitation, a modem, a network card (wireless or wired), an infra-red communication device, a wireless communication device and/or chipset (such as a Bluetooth™ device, an 802.11 device, a WiFi device, a WiMax device, a WWAN device, cellular communication facilities, etc.), and/or the like. The communications subsystem 630 may permit data to be exchanged with a network (such as the network described below, to name one example), with other computer or hardware systems, and/or with any other devices described herein. In many embodiments, the computer or hardware system 600 will further comprise a working memory 635, which can include a RAM or ROM device, as described above.

The computer or hardware system 600 also may comprise software elements, shown as being currently located within the working memory 635, including an operating system 640, device drivers, executable libraries, and/or other code, such as one or more application programs 645, which may comprise computer programs provided by various embodiments (including, without limitation, hypervisors, virtual machines (“VMs”), and the like), and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be encoded and/or stored on a non-transitory computer readable storage medium, such as the storage device(s) 625 described above. In some cases, the storage medium might be incorporated within a computer system, such as the system 600. In other embodiments, the storage medium might be separate from a computer system (i.e., a removable medium, such as a compact disc, etc.), and/or provided in an installation package, such that the storage medium can be used to program, configure, and/or adapt a general purpose computer with the instructions/code stored thereon. These instructions might take the form of executable code, which is executable by the computer or hardware system 600 and/or might take the form of source and/or installable code, which, upon compilation and/or installation on the computer or hardware system 600 (e.g., using any of a variety of generally available compilers, installation programs, compression/decompression utilities, etc.) then takes the form of executable code.

It will be apparent to those skilled in the art that substantial variations may be made in accordance with specific requirements. For example, customized hardware (such as programmable logic controllers, field-programmable gate arrays, application-specific integrated circuits, and/or the like) might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer or hardware system (such as the computer or hardware system 600) to perform methods in accordance with various embodiments of the invention. According to a set of embodiments, some or all of the procedures of such methods are performed by the computer or hardware system 600 in response to processor 610 executing one or more sequences of one or more instructions (which might be incorporated into the operating system 640 and/or other code, such as an application program 645) contained in the working memory 635. Such instructions may be read into the working memory 635 from another computer readable medium, such as one or more of the storage device(s) 625. Merely by way of example, execution of the sequences of instructions contained in the working memory 635 might cause the processor(s) 610 to perform one or more procedures of the methods described herein.

The terms “machine readable medium” and “computer readable medium,” as used herein, refer to any medium that participates in providing data that causes a machine to operate in a specific fashion. In an embodiment implemented using the computer or hardware system 600, various computer readable media might be involved in providing instructions/code to processor(s) 610 for execution and/or might be used to store and/or carry such instructions/code (e.g., as signals). In many implementations, a computer readable medium is a non-transitory, physical, and/or tangible storage medium. Such a medium may take many forms, including, but not limited to, non-volatile media, volatile media, or the like. Non-volatile media includes, for example, optical and/or magnetic disks, such as the storage device(s) 625. Volatile media includes, without limitation, dynamic memory, such as the working memory 635. In some alternative embodiments, a computer readable medium may take the form of transmission media, which includes, without limitation, coaxial cables, copper wire and fiber optics, including the wires that comprise the bus 605, as well as the various components of the communication subsystem 630 (and/or the media by which the communications subsystem 630 provides communication with other devices). In an alternative set of embodiments, transmission media can also take the form of waves (including without limitation radio, acoustic and/or light waves, such as those generated during radio-wave and infra-red data communications).

Common forms of physical and/or tangible computer readable media include, for example, a floppy disk, a flexible disk, a hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read instructions and/or code.

Various forms of computer readable media may be involved in carrying one or more sequences of one or more instructions to the processor(s) 610 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer or hardware system 600. These signals, which might be in the form of electromagnetic signals, acoustic signals, optical signals, and/or the like, are all examples of carrier waves on which instructions can be encoded, in accordance with various embodiments of the invention.

The communications subsystem 630 (and/or components thereof) generally will receive the signals, and the bus 605 then might carry the signals (and/or the data, instructions, etc. carried by the signals) to the working memory 635, from which the processor(s) 605 retrieves and executes the instructions. The instructions received by the working memory 635 may optionally be stored on a storage device 625 either before or after execution by the processor(s) 610.

According to various embodiments, system 600, particularly for embodiments of the apparatuses 100, 105, and/or 405, might further comprise one or more sensors 650, including, but not limited to, one or more weight measurement sensors, one or more rotation sensors, and/or the like. In some cases, as described above, the one or more weight measurement sensors might each comprise a load cell selected from a group consisting of a strain gauge load cell, a piezoelectric load cell, a capacitive load cell, a compression load cell, a compression/tension load cell, an S-beam load cell, a bending beam load cell, a platform load cell, a single point load cell, a canister load cell, and a low profile load cell, or the like. In some instances, also as described above, the one or more rotation sensors might each comprise one of an accelerometer, a gyroscope, a rotary encoder, an inclinometer, a rotary variable differential transformer, or a tilt sensor, and/or the like. The processor(s) 610, the operating system 640, and/or the application(s) 645 might utilize the measurements taken by the one or more weight measurement sensors and the one or more rotation sensors to calculate, in a manner as described in detail above with respect to FIGS. 1-5, a processed signal weight of an item that takes into account angle of tilt and/or angle of rotation of the item with respect to the weight measure sensor, another portion of the handheld apparatus, and/or the gravitational direction of the Earth that typically affect weight measurement readings in conventional weight measurement devices.

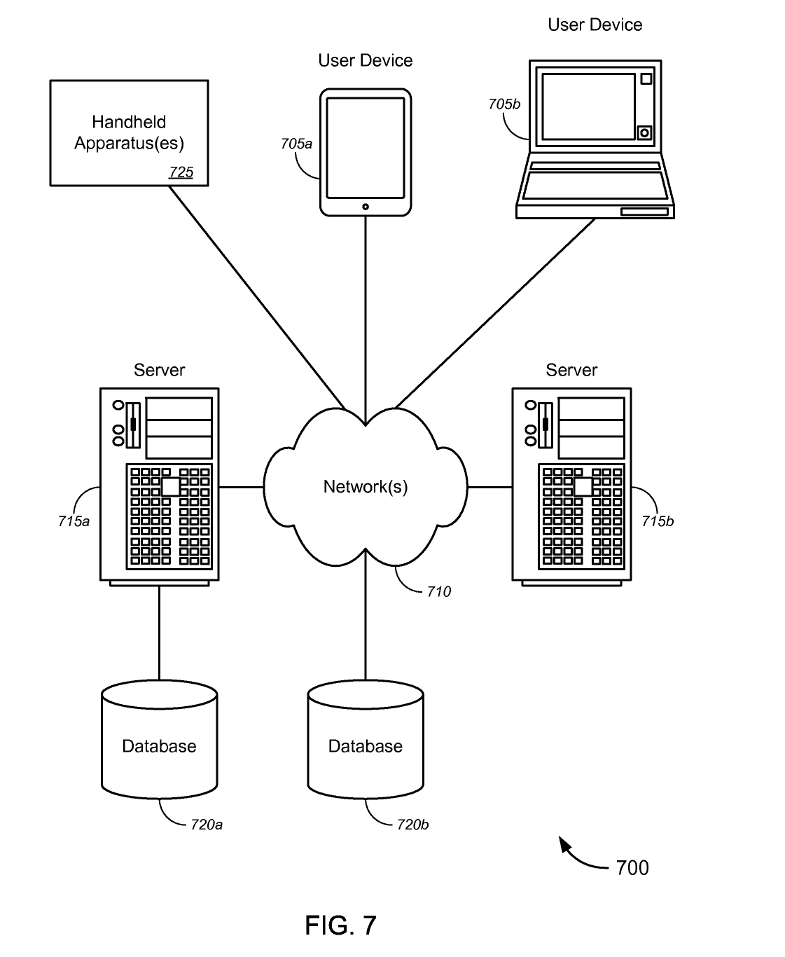

As noted above, a set of embodiments comprises methods and systems for implementing electronic weight measurement using a handheld apparatus (e.g., fishing net, etc.) that, in some cases, takes into account measurement deviations due to rotational or tilt orientation of the handheld apparatus during measurement. FIG. 7 illustrates a schematic diagram of a system 700 that can be used in accordance with one set of embodiments. The system 700 can include one or more user computers or user devices 705. A user computer or user device 705 can be a general purpose personal computer (including, merely by way of example, desktop computers, tablet computers, laptop computers, handheld computers, and the like, running any appropriate operating system, several of which are available from vendors such as Apple, Microsoft Corp., and the like), cloud computing devices, a server(s), and/or a workstation computer(s) running any of a variety of commercially-available UNIX™ or UNIX-like operating systems. A user computer or user device 705 can also have any of a variety of applications, including one or more applications configured to perform methods provided by various embodiments (as described above, for example), as well as one or more office applications, database client and/or server applications, and/or web browser applications. Alternatively, a user computer or user device 705 can be any other electronic device, such as a thin-client computer, Internet-enabled mobile telephone, and/or personal digital assistant, capable of communicating via a network (e.g., the network(s) 710 described below) and/or of displaying and navigating web pages or other types of electronic documents. Although the exemplary system 700 is shown with two user computers or user devices 705, any number of user computers or user devices can be supported.

Certain embodiments operate in a networked environment, which can include a network(s) 710. The network(s) 710 can be any type of network familiar to those skilled in the art that can support data communications using any of a variety of commercially-available (and/or free or proprietary) protocols, including, without limitation, TCP/IP, SNA™′ IPX™′ AppleTalk™, and the like. Merely by way of example, the network(s) 710 can each include a local area network (“LAN”), including, without limitation, a fiber network, an Ethernet network, a Token-Ring™ network and/or the like; a wide-area network (“WAN”); a wireless wide area network (“WWAN”); a virtual network, such as a virtual private network (“VPN”); the Internet; an intranet; an extranet; a public switched telephone network (“PSTN”); an infra-red network; a wireless network, including, without limitation, a network operating under any of the IEEE 802.11 suite of protocols, the Bluetooth™ protocol known in the art, and/or any other wireless protocol; and/or any combination of these and/or other networks. In a particular embodiment, the network might include an access network of the service provider (e.g., an Internet service provider (“ISP”)). In another embodiment, the network might include a core network of the service provider, and/or the Internet.

Embodiments can also include one or more server computers 715. Each of the server computers 715 may be configured with an operating system, including, without limitation, any of those discussed above, as well as any commercially (or freely) available server operating systems. Each of the servers 715 may also be running one or more applications, which can be configured to provide services to one or more clients 705 and/or other servers 715.

Merely by way of example, one of the servers 715 might be a data server, a web server, a cloud computing device(s), or the like, as described above. The data server might include (or be in communication with) a web server, which can be used, merely by way of example, to process requests for web pages or other electronic documents from user computers 705. The web server can also run a variety of server applications, including HTTP servers, FTP servers, CGI servers, database servers, Java servers, and the like. In some embodiments of the invention, the web server may be configured to serve web pages that can be operated within a web browser on one or more of the user computers 705 to perform methods of the invention.

The server computers 715, in some embodiments, might include one or more application servers, which can be configured with one or more applications accessible by a client running on one or more of the client computers 705 and/or other servers 715. Merely by way of example, the server(s) 715 can be one or more general purpose computers capable of executing programs or scripts in response to the user computers 705 and/or other servers 715, including, without limitation, web applications (which might, in some cases, be configured to perform methods provided by various embodiments). Merely by way of example, a web application can be implemented as one or more scripts or programs written in any suitable programming language, such as Java™, C, C#™ or C++, and/or any scripting language, such as Perl, Python, or TCL, as well as combinations of any programming and/or scripting languages. The application server(s) can also include database servers, including, without limitation, those commercially available from Oracle™, Microsoft™, Sybase™, IBM™, and the like, which can process requests from clients (including, depending on the configuration, dedicated database clients, API clients, web browsers, etc.) running on a user computer or user device 705 and/or another server 715. In some embodiments, an application server can perform one or more of the processes for implementing electronic weight measurement using a handheld apparatus (e.g., fishing net, etc.) that, in some cases, takes into account measurement deviations due to rotational, tilt, or angular orientation of the handheld apparatus during measurement, or the like, as described in detail above. Data provided by an application server may be formatted as one or more web pages (comprising HTML, JavaScript, etc., for example) and/or may be forwarded to a user computer 705 via a web server (as described above, for example). Similarly, a web server might receive web page requests and/or input data from a user computer 705 and/or forward the web page requests and/or input data to an application server. In some cases, a web server may be integrated with an application server.

In accordance with further embodiments, one or more servers 715 can function as a file server and/or can include one or more of the files (e.g., application code, data files, etc.) necessary to implement various disclosed methods, incorporated by an application running on a user computer 705 and/or another server 715. Alternatively, as those skilled in the art will appreciate, a file server can include all necessary files, allowing such an application to be invoked remotely by a user computer or user device 705 and/or server 715.

It should be noted that the functions described with respect to various servers herein (e.g., application server, database server, web server, file server, etc.) can be performed by a single server and/or a plurality of specialized servers, depending on implementation-specific needs and parameters.

In certain embodiments, the system can include one or more databases 720. The location of the database(s) 720 is discretionary: merely by way of example, a database 720a might reside on a storage medium local to (and/or resident in) a server 715a (and/or a user computer or user device 705). Alternatively, a database 720b can be remote from any or all of the computers 705, 715, so long as it can be in communication (e.g., via the network 710) with one or more of these. In a particular set of embodiments, a database 720 can reside in a storage-area network (“SAN”) familiar to those skilled in the art. (Likewise, any necessary files for performing the functions attributed to the computers 705, 715 can be stored locally on the respective computer and/or remotely, as appropriate.) In one set of embodiments, the database 720 can be a relational database, such as an Oracle database, that is adapted to store, update, and retrieve data in response to SQL-formatted commands. The database might be controlled and/or maintained by a database server, as described above, for example.

According to some embodiments, system 700 might further comprise one or more handheld apparatuses 725, as described in detail above with respect to FIGS. 1-5. The one or more handheld apparatuses 725 might generally correspond to apparatuses 100, 105, and/or 405 of FIGS. 1-4, while the user computers or user devices 705 might generally correspond to user devices or computing systems 265 and/or 410 of FIGS. 2B and 4.

While certain features and aspects have been described with respect to exemplary embodiments, one skilled in the art will recognize that numerous modifications are possible. For example, the methods and processes described herein may be implemented using hardware components, software components, and/or any combination thereof. Further, while various methods and processes described herein may be described with respect to particular structural and/or functional components for ease of description, methods provided by various embodiments are not limited to any particular structural and/or functional architecture but instead can be implemented on any suitable hardware, firmware and/or software configuration. Similarly, while certain functionality is ascribed to certain system components, unless the context dictates otherwise, this functionality can be distributed among various other system components in accordance with the several embodiments.

Moreover, while the procedures of the methods and processes described herein are described in a particular order for ease of description, unless the context dictates otherwise, various procedures may be reordered, added, and/or omitted in accordance with various embodiments. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with—or without—certain features for ease of description and to illustrate exemplary aspects of those embodiments, the various components and/or features described herein with respect to a particular embodiment can be substituted, added and/or subtracted from among other described embodiments, unless the context dictates otherwise. Consequently, although several exemplary embodiments are described above, it will be appreciated that the invention is intended to cover all modifications and equivalents within the scope of the following claims.

What is claimed is:

1. A method, comprising:
measuring, with a weight measurement sensor of a handheld apparatus, a raw signal weight of an item in load-bearing connection with the handheld apparatus;
measuring, with a rotation sensor of the handheld apparatus, at least one of angle of tilt or angle of rotation of the item with respect to at least one of the weight measurement sensor or a handle of the handheld apparatus;
calculating, with a processor of the handheld apparatus, a processed signal weight of the item based at least in part on the measured at least one of angle of tilt or angle of rotation of the item with respect to the at least one of the weight measurement sensor or the handle; and
displaying the processed signal weight of the item.

2. The method of claim 1, wherein the handheld apparatus comprises one of a handheld fishing net, a fishing rod, a handheld measuring rod, a handheld measuring scale, a handheld item-lifting rod, a shoulder-mounted carrying rod, or a handheld baggage scale.

3. The method of claim 1, wherein the item comprises one of a fish, a small mammal, a small reptile, a food item, a manufactured item, one or more carrying containers, or a piece of baggage.

4. The method of claim 1, wherein the weight measurement sensor comprises a load cell selected from a group consisting of a strain gauge load cell, a piezoelectric load cell, a capacitive load cell, a compression load cell, a compression/tension load cell, an S-beam load cell, a bending beam load cell, a platform load cell, a single point load cell, a canister load cell, and a low profile load cell.

5. The method of claim 1, wherein the rotation sensor comprises one of an accelerometer, a gyroscope, a rotary encoder, an inclinometer, a rotary variable differential transformer, or a tilt sensor.

6. The method of claim 1, wherein measuring the at least one of angle of tilt or angle of rotation of the item further comprises measuring, with the rotation sensor of the handheld apparatus, at least one of angle of tilt or angle of rotation of the item with reference to gravitational direction of the Earth.

7. The method of claim 1, wherein displaying the processed signal weight of the item comprises displaying, on a display device of the handheld apparatus, the processed signal weight of the item.

8. The method of claim 1, wherein displaying the processed signal weight of the item comprises sending, with a wireless communications device of the handheld apparatus and to one or more external user devices for display on a display device of at least one of the one or more external user devices, the processed signal weight of the item.

9. The method of claim 8, wherein the one or more external user devices comprises at least one of a smart phone, a mobile phone, a smart watch, a personal digital assistant, a tablet computer, a laptop computer, a desktop computer, or a stand-alone display device.

10. The method of claim 1, further comprising:
storing, on a data storage device of the handheld apparatus, the processed signal weight of the item.

11. A handheld apparatus, comprising:
a weight measurement sensor that is configured to measure a raw signal weight of an item in load-bearing connection with the handheld apparatus;
a rotation sensor that is configured to measure at least one of angle of tilt or angle of rotation of the item with respect to at least one of the weight measurement sensor or a handle of the handheld apparatus;
a processor that is configured to calculate a processed signal weight of the item based at least in part on the measured at least one angle of tilt or angle of rotation of the item with respect to the at least one of the weight measurement sensor or the handle; and
a display device that is configured to display the processed signal weight of the item.

12. The handheld apparatus of claim 11, wherein the handheld apparatus comprises one of a handheld fishing net, a fishing rod, a handheld measuring rod, a handheld measuring scale, a handheld item-lifting rod, a shoulder-mounted carrying rod, or a handheld baggage scale

13. The handheld apparatus of claim 11, wherein the item comprises one of a fish, a small mammal, a small reptile, a food item, a manufactured item, one or more carrying containers, or a piece of baggage.

14. The handheld apparatus of claim 11, wherein the weight measurement sensor comprises a load cell selected from a group consisting of a strain gauge load cell, a piezoelectric load cell, a capacitive load cell, a compression load cell, a compression/tension load cell, an S-beam load cell, a bending beam load cell, a platform load cell, a single point load cell, a canister load cell, and a low profile load cell.

15. The handheld apparatus of claim 11, wherein the rotation sensor comprises one of an accelerometer, a gyroscope, a rotary encoder, an inclinometer, a rotary variable differential transformer, or a tilt sensor.

16. The handheld apparatus of claim 11, wherein the rotation sensor is further configured to measure at least one of angle of tilt or angle of rotation of the item with reference to gravitational direction of the Earth.

17. The handheld apparatus of claim 11, further comprising:
a wireless communications device that is configured to send the processed signal weight of the item to one or more external user devices for display on a display device of at least one of the one or more external user devices.

18. The handheld apparatus of claim 17, wherein the one or more external user devices comprises at least one of a smart phone, a mobile phone, a smart watch, a personal digital assistant, a tablet computer, a laptop computer, a desktop computer, or a stand-alone display device.

19. The handheld apparatus of claim 11, further comprising:
a data storage device that is configured to store the processed signal weight of the item.

20. A weight measurement system for use in conjunction with a handheld apparatus, comprising:
at least one processor; and
at least one non-transitory computer readable medium in communication with the at least one processor, the at least one non-transitory computer readable medium having stored thereon computer software comprising a set of instructions that, when executed by the at least one processor, causes the weight measurement system to perform one or more functions, the set of instructions comprising:
instructions for receiving a raw signal weight measurement of an item in load-bearing connection with the handheld apparatus;
instructions for receiving at least one of a measured angle or a measured rotation of the item with respect to at least one of a weight measurement sensor or a handle of the handheld apparatus;
instructions for calculating a processed signal weight of the item based at least in part on the at least one of the measured angle or the measured rotation of the item with respect to the at least one of the weight measurement sensor or the handle;
instructions for sending the processed signal weight of the item for display on a display device.
